(19) United States
(12) Patent Application Publication
(10) Pub. No.: US 2006/0181338 A1
(43) Pub. Date: Aug. 17, 2006

(54) Stacked CMOS current mirror using MOSFETs having different threshold voltages

(75) Inventors: Jeongwook Koh, Seoul (KR); Chun-deok Suh, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/354,944

(22) Filed: Feb. 16, 2006

(30) Foreign Application Priority Data
Feb. 17, 2005 (KR) 10-2005-0013260

(51) Int. Cl. G05F 1/10

(52) U.S. Cl. 327/543

(57) ABSTRACT

A stacked CMOS current mirror using metal oxide semiconductor field effect transistors (MOSFETs) having different threshold voltages is disclosed. The stacked CMOS current mirror includes a first MOSFET having a source and a gate which are connected to a first input current terminal, a second MOSFET having a source connected to a drain of the first MOSFET, a gate connected to the gate of the first MOSFET, and a drain connected to ground, a third MOSFET having a drain connected to a second input current terminal and a gate connected to the source and the gate of the first MOSFET, and a fourth MOSFET having a drain connected to a source of the third MOSFET, a gate connected to the source and the gate of the first MOSFET, and a source connected to the ground.

This application claims priority from Korean Patent Application No. 10-2005-0013260, filed on Feb. 17, 2005, the entire content of which is incorporated herein by reference.

### BACKGROUND OF THE INVENTION

1. Field of the Invention

The invention relates to a stacked complementary metal oxide semiconductor (CMOS) current mirror. More particularly, the present invention relates to a stacked CMOS current mirror capable of sufficiently securing an output voltage swing range by decreasing the minimum saturation output operating voltage of the current mirror using metal oxide semiconductor field effect transistors (MOSFETs).

2. Description of the Related Art

Recently, as the integration of integrated circuit is increased, it has been required to design an integrated circuit which operates at low voltage and has an improved characteristic. However, it is difficult to implement an integrated circuit which operates at low voltage. In particular, it is difficult to implement a current mirror for an MOS analog circuit that operates at low voltage and has an improved characteristic. In an MOS analog circuit, a current mirror is used in the case where a stabilized and predictable DC reference current is produced at a certain point of the circuit and it is required that DC currents in proportion to the DC reference current are created.

The current mirror is generally composed of MOSFETs. The respective MOSFETs should operate in a saturation region in order for the current mirror to operate properly. Further, it is necessary to decrease the minimum voltage at which the MOSFETs begin to operate in the saturation region (hereinafter referred to as the “minimum saturation operating voltage”) in order to operate the current mirror at low voltage. Furthermore, it is necessary to increase the output resistance of the current mirror in order to sufficiently secure the output voltage swing range.

In the conventional current mirror, however, both the minimization of the minimum saturation operating voltage and the securing of the output voltage swing range are not satisfied.

FIG. 1 is a circuit diagram of a conventional CMOS current mirror. The conventional CMOS current mirror as illustrated in FIG. 1 is a CMOS current mirror illustrated and described in the publication entitled “CMOS Analog Circuit Design” by P. E. Allen and D. R. Holberg.

As shown in FIG. 1, a MOSFET M1 has a drain and a gate commonly connected to a reference current source Iref, and a source connected to ground. A MOSFET M2 has a drain connected to a current source Iout, a gate connected to the gate of the MOSFET M1, and a source connected to ground. In the above construction, the minimization of the minimum saturation operating voltage is satisfied because only the minimum voltage headroom Δ₁ is required to operate the MOSFETs M1 and M2 in the saturation region.

FIG. 2 is a view explaining a problem of the conventional CMOS current mirror. Referring to FIG. 2, the conventional CMOS current mirror does not satisfy the securing requirement of the output voltage swing range because an error in that the reference current Iref does not coincide with the current-mirrored current occurs due to the small output resistance of the current mirror.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides a stacked CMOS current mirror which can minimize the minimum saturation operating voltages of the MOSFETs and to sufficiently secure an output voltage swing range by using MOSFETs having different threshold voltages for improving the output resistance of the current mirror.

According to an aspect of the present invention, there is provided a stacked CMOS current mirror, according to the present invention, which comprises a first MOSFET having a source and a gate which are connected to a first input current terminal, a second MOSFET having a source connected to a drain of the first MOSFET, a gate connected to the gate of the first MOSFET, and a drain connected to ground, a third MOSFET having a drain connected to a second input current terminal and a gate connected to the source and the gate of the first MOSFET, and a fourth MOSFET having a drain connected to a source of the third MOSFET, a gate connected to the source and the gate of the first MOSFET, and a source connected to the ground.

The first and third MOSFETs may be n-channel field effect transistors (nFETs), and the second and fourth MOSFETs may be low power nFETs (LpnFETs).

The first and third MOSFETs may be p-channel field effect transistors (pFETs), and the second and fourth MOSFETs may be low power pFETs (LppFETs).

The threshold voltage of the second and fourth MOSFETs may be higher than that of the first and third MOSFETs.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a circuit diagram of a conventional CMOS current mirror;

FIG. 2 is a view explaining the problem of the conventional CMOS current mirror;

FIG. 3 is a circuit diagram of a stacked CMOS current mirror according to an exemplary embodiment of the present invention;

FIG. 4 is an equivalent circuit diagram of half of a stacked CMOS current mirror according to an exemplary embodiment of the present invention;

FIG. 5 is a view explaining an effect of a stacked CMOS current mirror according to an exemplary embodiment of the present invention; and

FIG. 6 is a view explaining another effect of a stacked CMOS current mirror according to an exemplary embodiment of the present invention.

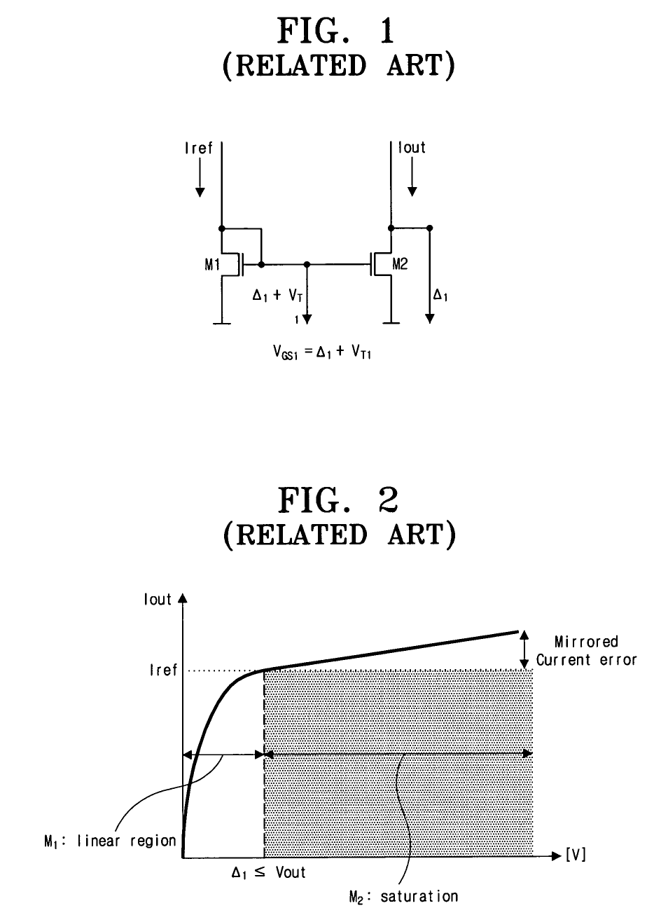

### DETAILED DESCRIPTION OF THE EXEMPLARY EMBODIMENTS

Certain exemplary embodiments of the present invention will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

FIG. 3 is a circuit diagram of a CMOS current mirror according to an exemplary embodiment of the present invention.

Referring to FIG. 3, the stacked CMOS current mirror according to the present invention includes four MOSFETs M1, M2, M3 and M4.

The MOSFET M1 has a source and a gate which are connected to a first input current (I1) terminal. The MOSFET M2 has a source connected to a drain of the MOSFET M1, a gate connected to the source and the gate of the MOSFET M1, and a drain connected to ground.

The MOSFET M3 has a drain connected to a second input current (I2) terminal and a gate connected to the source and the gate of the MOSFET M1. The MOSFET M4 has a drain connected to a source of the MOSFET M3, a gate connected to the source and the gate of the MOSFET M1, and a source connected to ground.

The MOSFETs M1 and M2 and the MOSFETs M3 and M4 form pairs, respectively, and two pairs of the opposite transistors form the current mirror.

The MOSFETs M2 and M4 have a high threshold voltage (highVT), and the MOSFETs M1 and M3 have a regular threshold voltage (regVT).

Table 1 below shows MOSFETs that can be put in the stacked CMOS current mirror and their characteristics.

TABLE 1

| FET | condition | Wdesign/Ldesign | V_{T} |
|---|---|---|---|
| nFET | VD = 1.5 V, VB = 0 V | 10/0.12 | 0.350 ± 0.055 |
| pFET | VD = 1.5 V, VB = 0 V | 10/0.12 | 0.300 ± 0.055 |
| lpnFET | VD = 1.2 V, VB = 0 V | 10/0.12 | 0.500 ± 0.055 |
| lppFET | VD = 1.2 V, VB = 0 V | 10/0.12 | 0.450 ± 0.055 |

As shown in Table 1, lpnFETs having a high threshold voltage of 0.500±0.055 may be used as the MOSFETs M2 and M4, and nFETs having a regular threshold voltage of 0.350±0.055 may be used as the MOSFETs M1 and M3. Also, lppFETs having a high threshold voltage of 0.450±0.055 may be used as the MOSFETs M2 and M4, and pFETs having a regular threshold voltage of 0.300±0.055 may be used as the MOSFETs M1 and M3.

Equation (1) represents a condition under which the MOSFET M4 operates in a saturation region.
V_{GS4}−V_{T4}≦V_{DS4} (1)

In Equation (1), V_{GS4} indicates the gate-source voltage of the MOSFET M4, V_{T4} indicates the threshold voltage of the MOSFET M4, and V_{DS4} indicates the drain-source voltage of the MOSFET M4. In order for the MOSFET M4 to operate in the saturation region, the voltage difference between the drain-source voltage V_{DS4} and the gate-source voltage V_{GS4} should be lower than the threshold voltage V_{T4}. This condition may be represented as Equation (1). Since the gate-source voltage V_{GS4} is equal to the voltage Δ₃+V_{T3}+V_{A} at node B, the V_{GS4}−V_{T4} is given by V_{GS4}−V_{T4}=Δ₃+V_{T3}+V_{A}−V_{T4}. Here, Δ₃ indicates a micro-voltage of the MOSFET M3 that is higher than 0, and V_{T3} indicates the threshold voltage of the MOSFET M3. Since the drain-source voltage V_{DS4} is equal to the voltage V_{A} at node A, Equation (1) may be represented as Δ₃+V_{T3}+V_{A}−V_{T4}≦VA, which may be arranged as Δ₃≦V_{T4}−V₃. Here, since Δ₃ is the micro-voltage higher than 0, Δ₃≦V_{T4}−V_{T3} may be represented as V_{T4}−V_{T3}≧0. It can be known by the derived V_{T4}−V_{T3} that the threshold voltage V_{T4} of MOSFET M4 is higher than the threshold voltage V_{T3} of MOSFET M3.

Provided all of the MOSFETs M1, M2, M3 and M4 operate in the saturation region, VA is calculated by Equation (2).

$${V}_{A} = {Δ}_{4} + {V}_{T 4} - ( {Δ}_{3} + {V}_{T 3} ) \\ {V}_{A} = \sqrt{\frac{2 {β}_{1}}{I}} + {V}_{T 4} - ( \sqrt{\frac{2 {β}_{2}}{I}} + {V}_{T 3} ) \\ {V}_{A} = \sqrt{\frac{2 {β}_{1}}{I}} - \sqrt{\frac{2 {β}_{3}}{I}} + ( {V}_{T 4} - {V}_{T 3} ) , {β}_{1} = {β}_{2} \\ {V}_{A} ∼ {V}_{T 4} - {V}_{T 3} \qquad ( 2 )$$

As is derived from Equation (2), if

$${Δ}_{4} = \sqrt{\frac{2 {β}_{1}}{I}} , {Δ}_{3} = \sqrt{\frac{2 {β}_{2}}{I}}$$

and β₁=β₂, V_{A}˜V_{T4}−V_{T3} is calculated.

Equation (3) is an equation that calculates the minimum saturation operating voltage according to the present invention using Equation (2).
Vₘᵢₙ=Δ₃+(V_{T4}−V_{T3}) (3)

Accordingly, if V_{A} derived from Equation (2) is applied to the voltage (V_{C}=Vₘᵢₙ=Δ₃+V_{A}) at node C, the minimum saturation operating voltage Vₘᵢₙ results in Vₘᵢₙ=Δ₃+(V_{T4}−V_{T3}).

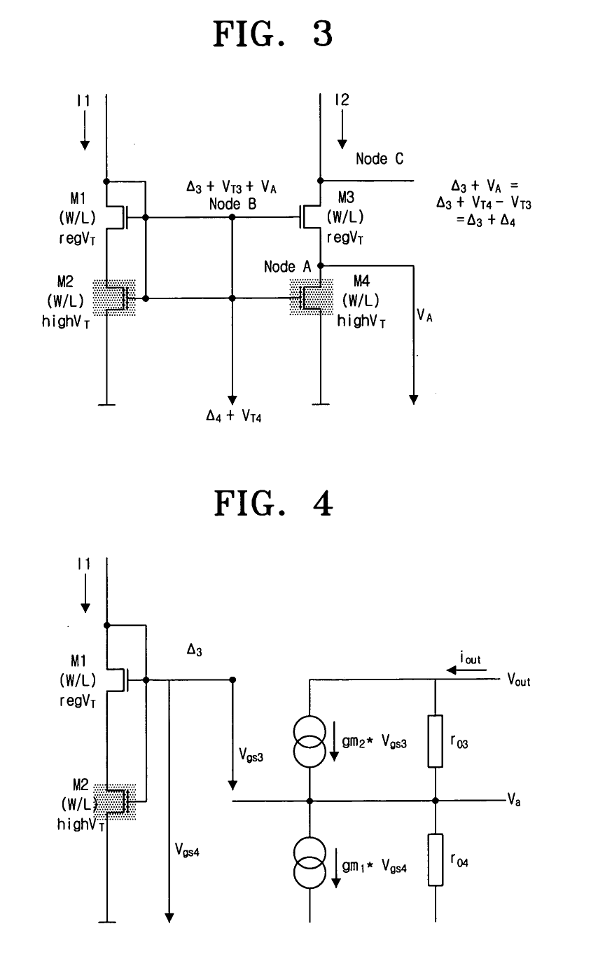

FIG. 4 is an equivalent circuit diagram of half of a stacked CMOS current mirror according to an exemplary embodiment of the present invention.

As shown in FIG. 4, a voltage source gm₂*v_{gs3} and a resistor rₒ₃ are connected in parallel between voltage v_{gs3} and voltage v_{gs4}, and a voltage gm₁*v_{gs4} and a resistor rₒ₄ are connected in parallel between voltage v_{gs4} and ground. Here, gm₂ denotes the transconductance of the MOSFET M3, gm₁ denotes the transconductance of the MOSFET M4. Since v_{gs4}=0 at a point of AC signal, the MOSFET M1 has an output resistance r₀₄ only, and v_{gs3}+vₐ=0.

Equations (4-1) to (4-4) are equations that calculate the output current at the output node.

$$\begin{matrix}{i}_{out} = {gm}_{2} {v}_{gs 3} + \frac{( {v}_{out} - {v}_{a} )}{{r}_{o 3}} & ( 4 \text{-} 1 ) \\ {i}_{out} = {gm}_{2} ( - {v}_{a} ) + \frac{( {v}_{out} - {v}_{a} )}{{r}_{o 3}} & ( 4 \text{-} 2 ) \\ {v}_{a} = {i}_{out} {r}_{o4} & ( 4 \text{-} 3 ) \\ {i}_{out} = {gm}_{2} ( - {i}_{out} {r}_{o 4} ) + \frac{( {v}_{out} - {i}_{out} {r}_{o 4} )}{{r}_{o 3}} & ( 4 \text{-} 4 )\end{matrix}$$

Since v_{gs3}=−vₐ in v_{gs3}+vₐ=0, Equation (4-2) is obtained by substituting this in Equation (4-1). Also, Equation (4-4), which calculates the output current at the output node, is obtained by substituting Equation (4-3) in Equation (4-2).

Equation 5 is an equation that calculates the output resistance.

$${r}_{out} = \frac{{v}_{out}}{{i}_{out}} = {r}_{04} + {r}_{03} + {gm}_{2} {r}_{04} {r}_{03} ∼ {gm}_{2} {r}_{04} {r}_{03} \qquad ( 5 )$$

By substituting Equations (4-4) in Equation (5), the output resistance

$${r}_{out} = \frac{{v}_{out}}{{i}_{out}} = {r}_{o 4} + {r}_{o 3} + {gm}_{2} {r}_{o 4} {r}_{o 3}$$

is obtained. Here, upon ignoring the resistances r₀₄ and r₀₃ having small values, the output resistance may be calculated from rₒᵤₜ˜gm₂r₀₄r₀₃ as its approximate value.

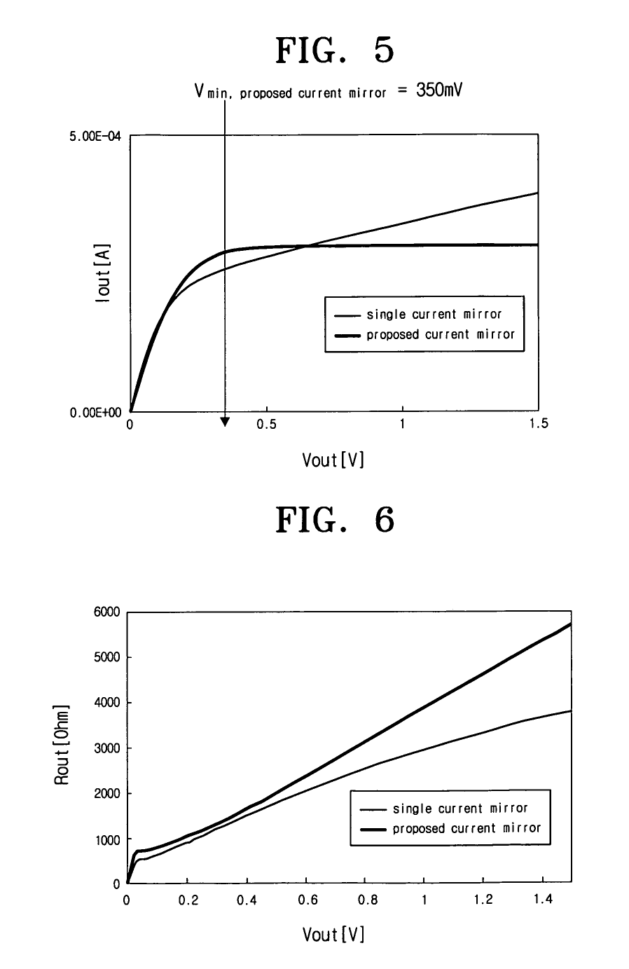

FIG. 5 is a view explaining an effect of a stacked CMOS current mirror according to an exemplary embodiment of the present invention.

Referring to FIG. 5, an output current according to the change of the output voltage of the proposed current mirror and the output current according to the change of the output voltage of the conventional single current mirror are illustrated. It can be seen that the stacked CMOS current mirror according to the present invention has the minimum saturation operating voltage of 350 mV that is significantly lower than that of the conventional single current mirror. The minimum saturation operating voltage of the stacked CMOS current mirror according to the present invention is calculated using Equation (3). Accordingly, the minimum saturation operating voltage at which the MOSFETs that constitute the stacked CMOS current mirror begin to operate in the saturation region is decreased, and thus the CMOS current mirror can operate at low voltage.

FIG. 6 is a view explaining another effect of a stacked CMOS current mirror according to an exemplary embodiment of the present invention.

Referring to FIG. 6, the output resistance according to the change of the output voltage of the proposed current mirror and the output resistance according to the change of the output voltage of the conventional single current mirror are illustrated. It can be seen that the stacked CMOS current mirror according to the present invention has the output resistance that is significantly higher than that of the conventional single current mirror. The output resistance of the stacked CMOS current mirror according to the present invention is calculated using Equation (5). As shown in FIG. 5, as the output resistance increases, a sufficient output voltage swing range is secured. Accordingly, the linearity of the current mirror increases and this causes the characteristic of the current source to be improved.

As described above, according to the present invention, both the minimization of the minimum saturation operating voltage and the securing of the output voltage swing range are satisfied, and thus current mirror can operate at low voltage with its linearity increased.

The foregoing embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A stacked complementary metal oxide semiconductor (CMOS) current mirror comprising:
a first metal oxide field effect transistor (MOSFET) having a source and a gate which are connected to a first input current terminal;
a second MOSFET having a source connected to a drain of the first MOSFET, a gate connected to the source and the gate of the first MOSFET, and a drain connected to ground;
a third MOSFET having a drain connected to a second input current terminal and a gate connected to the source and the gate of the first MOSFET; and
a fourth MOSFET having a drain connected to a source of the third MOSFET, a gate connected to the source and the gate of the first MOSFET, and a source connected to the ground.

2. The stacked CMOS current mirror as claimed in claim 1, wherein the first and third MOSFETs are n-channel field effect transistors (nFETs), and the second and fourth MOSFETs are low power nFETs (LpnFETs).

3. The stacked CMOS current mirror as claimed in claim 1, wherein the first and third MOSFETs are p-channel field effect transistors (pFETs), and the second and fourth MOSFETs are low power pFETs (LppFETs).

4. The stacked CMOS current mirror as claimed in claim 1, wherein a threshold voltage of the second and fourth MOSFETs is higher than a threshold voltage of the first and third MOSFETs.

5. The stacked CMOS current mirror as claimed in claim 4, wherein the threshold voltage of the second and fourth MOSFETs is approximately 0.45 to 0.5 V and the threshold voltage of the first and third MOSFETs is approximately 0.3 to 0.35 V.

6. The stacked CMOS current mirror as claimed in claim 1, wherein a minimum saturation operating voltage of the stacked CMOS current mirror is 350 mV.
